(19) United States
(12) Patent Application Publication
(10) Pub. No.: US 2009/0328208 A1
(43) Pub. Date: Dec. 31, 2009

(54) METHOD AND APPARATUS FOR PREVENTING PHISHING ATTACKS

(75) Inventor: Matthew F. Peters, Winchester (GB)

Correspondence Address: Snell & Wilmer L.L.P. (IBM Corp), 600 Anton Blvd, Suite 1400, Costa Mesa, CA, 92626, US

(73) Assignee: INTERNATIONAL BUSINESS MACHINES, Armonk, NY (US)

(21) Appl. No.: 12/165,513

(22) Filed: Jun. 30, 2008

(51) Int. Cl. G06F 21/00

(52) U.S. Cl. 726/22

(57) ABSTRACT

The disclosure generally relates to a method for preventing phishing attacks on a computer browser. The method includes the steps of: providing a web browser having a bookmark group; directing the browser to a first Uniform Resource Locator (“URL”) having a first URL address, the first URL address having a plurality of alpha-numeric characters pointing to a first IP address; saving the first URL address in the bookmark group as a first bookmark; receiving an email communication containing a second URL address, the second URL address having a plurality of alpha-numeric characters similar to the first URL address and purporting to point to the first IP address; comparing the first URL address with the second URL address; and determining whether the first URL address and the second URL address share an identical IP addresses.

### BACKGROUND

1. Field of the Invention

The disclosure relates to a method and apparatus for preventing phishing attacks. More specifically, the disclosure relates to a method and apparatus for preventing a phishing attack by using a browser to identify suspect URLs.

2. Description of Related Art

Recent years have seen an increase in the number of attacks on personal and corporate computers. Attacks range from imparting viruses to providing access to the owner's computer and personal information.

Phishing is the practice of sending emails that appear to come from a legitimate business source and which invite the recipient to visit the business' website and sign-on, using personal identification and password. The phishing email invariably contains a link to a website. The link is engineered to appear genuine and so does the first page of the website. In fact, both the link and the website to which the unsuspecting user is directed are fake. However, by the time the user has reached the fake website, she has already revealed her user identification and password to the hacker.

Conventional methods of dealing with phishing scams include maintaining an updated list of known phishing cites and making the list available to the public. Publishing known phishing cites is ineffective in combating phishing because the hackers regularly change the web identity.

Another conventional method includes providing an image, logo or a special phrase known only to the user on the first page of the website. If the phrase or image is missing and the user is alerted to the missing image or phrase, then authenticness of the website would be apparent. This approach is only effective however if the user is alert to the missing phrase or logo.

Another common class of phishing attacks involves providing a plausible looking Universal Resource Locator (“URL”). Such attacks involve sending a phishing email with a link that appears genuine. For example, the phishing email can display a different link to the user from the one that will be visited when the hypertext link is activated.

Even more difficult to spot are attacks in which the links and the URL appears genuine. Slight character changes can be made on the URL to trick the reader in believing authenticity of the URL. It is possible to construct a fake link and register a domain name with a name that is confusingly similar to the genuine site. For example, the sites (1) and (2) below are confusingly similar, yet only one is authentic:

www.barclays.co.uk (1)

www.barc1ays.co.uk (2)

In the above example, the first link is authentic. In the second link, however, the lower letter “l” is replaced by the number “1”. Clearly, only the most attentive reader would be able to identify the authentic website. Thus, there is a need for a method and apparatus to prevent increasingly sophisticated phishing attacks.

### SUMMARY

In one embodiment, the disclosure relates to a method for preventing phishing attacks on a computer browser, the method comprising: providing a web browser having a bookmark group; directing the browser to a first Uniform Resource Locator (“URL”) having a first URL address, the first URL address having a plurality of alpha-numeric characters pointing to a first IP address; saving the first URL address in the bookmark group as a first bookmark; receiving an email communication containing a second URL address, the second URL address having a plurality of alpha-numeric characters similar to the first URL address and purporting to point to the first IP address; comparing the first URL address with the second URL address; and determining whether the first URL address and the second URL address share an identical IP addresses; wherein the step of determining whether the first URL address and the second URL address share the an identical IP address includes at least one of (i) comparing each of the plurality of alpha-numeric characters of the first URL address with each of the plurality of alpha-numeric characters of the second URL address, respectively and/or (ii) comparing the first IP address with the purported first IP address.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a flow diagram for identifying phishing attacks according to one embodiment of the disclosure; and

FIG. 2 is a schematic representation of a circuit for implementing an embodiment of the disclosure.

### DETAILED DESCRIPTION

The most dangerous phishing attack is one which comes from businesses for which the client has acquired user ID and password. Such businesses are those frequented by the user, including financial centers, DMV records and utility companies. In such phishing attacks the user's mistaken belief in authenticity of the phishing website can lead to disastrous implications. To protect against these and similar phishing attacks, one embodiment of the disclosure relates to a method for preventing phishing attacks by storing the relevant URL at the user's bookmark. When an unsolicited and/or suspicious email containing a phishing URL is received, the user's browser compares the received URL to the bookmarked URL. If the received URL is different from the bookmarked URL, the browser alerts the user to the difference.

Every machine on the internet has a unique identifying number, called an IP Address. A typical IP address contains four sets of numbers separated by decimal points. For example, 151.207.245.67 defines an IP address. To make the IP address understandable to humans, the IP address is converted to alpha-numeric characters. Thus, IP address 151.207.245.67 corresponds to www.uspto.gov, which is the IP address for the U.S. Patent and Trademark Office.

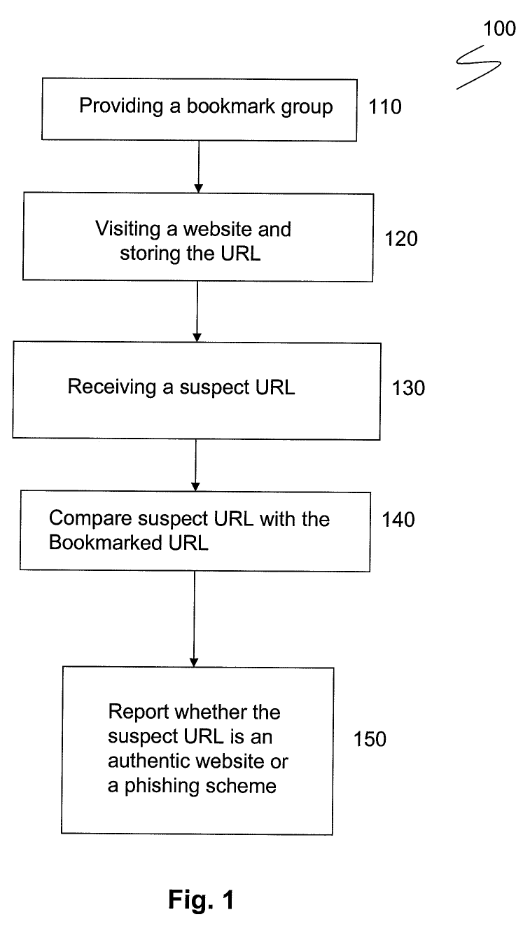

FIG. 1 is a flow diagram for identifying phishing attacks according to one embodiment of the disclosure. Flow diagram 100 can be implemented at conventional browsers. In step 110, the browser provides a bookmark group. The bookmark group can be a conventional grouping of favorite websites or frequently visited websites. Conventional browsers allow the user to store a website or link to the website for future access. Once a link is bookmarked, the browser will store a data link to the website. The user may access the website by selecting the desired website from the bookmark group.

In step 120, the user identifies a desired website on the browser. The desired website can be visited by typing its URL at the address toolbar of a browser or by using a search engine. Once the desired website is identified, the user can enter the site and store it as a favorite or a bookmark.

As stated a phishing attacks typically start by receiving an unsolicited email. The unsolicited email contains a subject line from a legitimate institution and the body of the email invites the user to log into an authentic-looking website. This is shown in step 130. The unsolicited email may contain a warning urging the user to rectify a situation by logging into the website. The unsolicited email may also contain a hyperlink text which purportedly contains the URL for the website. In some phishing attacks the URL contained in the unsolicited email (“the suspect URL”) alleges to be authentic URL.

In step 140, the browser compares the URL provided in the email with the URL bookmarked by the user. The comparison of step 140 can include providing a letter-by-letter comparison between the bookmarked URL with the suspect URL. In embodiment, the browser compares the IP address associated with the bookmarked URL with the IP address associated with the suspect URL.

In step 150, the browser reports its findings in step 140 by reporting whether the suspect URL is identical to the bookmarked URL. If the suspect URL is identical to the bookmarked URL, then the browser may display communication indicating that the URL contained in the email is authentic URL. On the other hand, if the suspect URL does not match the bookmarked URL, then the browser may display warnings to the user identifying the phishing attempt.

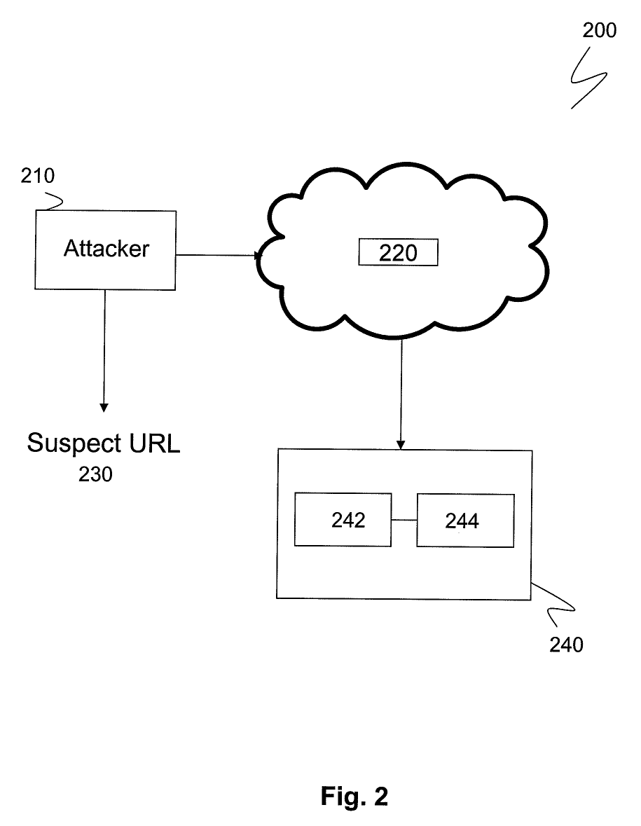

FIG. 2 is a schematic representation of a circuit for implementing an embodiment of the disclosure. In representation 200 of FIG. 2, attacker computer 210 sends user computer 240 an email with a link having a suspect URL 230 through internet 220. User computer 240 includes processor circuit 242 and memory circuit 244. Memory circuit 244 may include instructions for directing processor circuit 242 to perform one or more tasks.

In one embodiment, computer 240 is used to search the internet. Various websites are then bookmarked and stored at memory circuit 244. When attacker 210 sends an email with suspect URL 230 to computer 240, processor 242 can be tasked with identifying the suspect URL and determining whether suspect URL 230 is authentic.

In one embodiment of the disclosure, processor 242 execute instructions to compare the alpha-numeric address of suspect URL 230 with a known address bookmarked in memory 244. The process may include comparing each character of suspect URL 230 with a corresponding character of the bookmarked URL (not shown). Thus, if the suspect URL is “www.barc1ays.co.uk” and the bookmarked URL is “www.barclays.co.uk”, processor 242 can readily identify the discrepancy between the number “1” in the suspect URL and the letter “l” in the authentic URL. Once such determination has been made, the suspect URL can report the finding to the user.

In another embodiment of the disclosure, processor 242 compares the IP address associated with the suspect URL with the IP address bookmarked in memory 244. Comparing IP addresses can be done in addition to, or in combination with, comparing the alpha-numeric characters of the URLs. Comparing the IP addresses can also be done as the only means for detecting the suspect address.

The process of identifying a suspect URL can be started automatically upon receiving the email or it can be triggered by the user or an event. For example, the browser can be programmed with instructions to identify all emails containing a web link or a hypertext link. Thus, if an incoming email contains such a link, the browser automatically identifies the link and determines whether the link is authentic as described above. If the link is authentic, then the browser may leave the email message intact and undisturbed. On the other hand, if the suspect link is determined to be inauthentic, then the browser can delete the email, quarantine the email or simply remind the user that the email contains an unverifiable link.

In another embodiment, the browser checks the email only after being tasked by the user. Once activated, the processor compares the link as described herein and reports the authenticity of the link to the user.

While the principles of the disclosure have been illustrated in relation to the exemplary embodiments shown herein, the principles of the disclosure are not limited thereto and include any modification, variation or permutation thereof.

What is claimed is:

1. A method for preventing phishing attacks on a computer browser, the method comprising:
providing a web browser having a bookmark group;
directing the browser to a first Uniform Resource Locator (“URL”) having a first URL address, the first URL address having a plurality of alpha-numeric characters pointing to a first IP address;
saving the first URL address in the bookmark group as a first bookmark;
receiving an email communication containing a second URL address, the second URL address having a plurality of alpha-numeric characters similar to the first URL address and purporting to point to the first IP address;
comparing the first URL address with the second URL address; and
determining whether the first URL address and the second URL address share an identical IP addresses;
wherein the step of determining whether the first URL address and the second URL address share the an identical IP consists of (i) comparing each of the plurality of alpha-numeric characters of the first URL address with each of the corresponding plurality of alpha-numeric characters of the second URL address, respectively and (ii) comparing the first IP address with the purported first IP address.
